(19) United States
(12) Patent Application Publication
(10) Pub. No.: US 2022/0129149 A1
(43) Pub. Date: Apr. 28, 2022

(54) CONTROL DEVICE, SYSTEM, AND PROGRAM

(71) Applicant: KABUSHIKI KAISHA TOKAI RIKA DENKI SEISAKUSHO, Aichi (JP)

(72) Inventors: Keiji NOMURA, Aichi (JP); Toshihito TAKAI, Aichi (JP); Kenji MURATA, Aichi (JP); Keita NAKANE, Aichi (JP)

(73) Assignee: KABUSHIKI KAISHA TOKAI RIKA DENKI SEISAKUSHO, Aichi (JP)

(21) Appl. No.: 17/431,267

(22) PCT Filed: Feb. 20, 2020
(86) PCT No.: PCT/JP2020/006862

§ 371 Date: Aug. 16, 2021

(30) Foreign Application Priority Data
Mar. 26, 2019 (JP) 2019-059342
Feb. 3, 2020 (JP) 2020-016223

(51) Int. Cl. G06F 3/04886; G06F 3/04847; G06F 3/04845

(52) U.S. Cl. CPC G06F 3/04886; G06F 3/04845; G06F 3/04847

(57) ABSTRACT

[Object] To further improve operability.

[Solution] Provided is a control device including: a reception section configured to receive an operation performed on at least one operation section; and a control section configured to execute a notification process of controlling a notification section in such a manner that the notification section treats at least one of images displayed on a display section as a target image and makes a notification in tandem with the at least one target image that moves depending on a content of the operation received by the reception section. The operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

### TECHNICAL FIELD

The present invention relates to a control device, a system, and a program.

### BACKGROUND ART

In recent years, many systems that adopt graphical user interfaces have been developed. For example, Patent Literature 1 discloses a system that makes it possible to execute a function corresponding to a command input option displayed on a monitor when a touchpad is operated.

One of features of the system disclosed in Patent Literature 1 is that the touchpad has a shape, which is substantially consistent with the shape of a display area. This allows a user who operates the touchpad to intuitively understand a cursor position or the like on the display area, and perform any operation without always gazing at the monitor.

However, with regard to some of the systems that adopt the graphical user interfaces, it is difficult for the user to intuitively understand a correspondence between operation coordinates and display coordinates, the operation coordinates defining a position of the operation performed on an operation section, the display coordinates defining a position of an image displayed on a display section. In the case of using such a system, there is a possibility that the user may lose the position of the operation and operability may deteriorate.

### CITATION LIST

### Patent Literature

Patent Literature 1: JP 2003-108311A

### DISCLOSURE OF INVENTION

### Technical Problem

Accordingly, the present invention is made in view of the aforementioned issues, and an object of the present invention is to provide a mechanism that makes it possible to further improve the operability.

### Solution to Problem

To solve the above-described problems, according to an aspect of the present invention, there is provided a control device including: a reception section configured to receive an operation performed on at least one operation section; and a control section configured to execute a notification process of controlling a notification section in such a manner that the notification section treats at least one of images displayed on a display section as a target image and makes a notification in tandem with the at least one target image that moves depending on a content of the operation received by the reception section. The operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

In addition, to solve the above-described problems, according to another aspect of the present invention, there is provided a system including: at least one operation section; a reception section configured to receive an operation performed on the operation section; a display section configured to display at least one image; and a control section configured to execute a notification process of controlling a notification section in such a manner that the notification section treats at least one of images displayed on the display section as a target image and makes a notification in tandem with the at least one target image that moves depending on a content of the operation received by the reception section. The operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

In addition, to solve the above-described problems, according to another aspect of the present invention, there is provided a program that causes a computer to achieve: a reception function of receiving an operation performed on at least one operation section; and a control function of executing a notification process of controlling a notification section in such a manner that the notification section treats at least one of images displayed on a display section as a target image and makes a notification in tandem with the at least one target image that moves depending on a content of the operation received by the reception section. The operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

### Advantageous Effects of Invention

As described above, according to the present invention, it is possible to provide the mechanism that makes it possible to further improve operability.

### BRIEF DESCRIPTION OF DRAWINGS

FIG. 1 is a diagram illustrating a functional configuration example of a system 1 according to an embodiment of the present invention.

FIG. 2 is a diagram for describing a notification process performed by a control section 420 according to the embodiment.

FIG. 3 is a diagram for describing a notification process performed by the control section 420 according to the embodiment.

FIG. 4 is a diagram for describing a notification process performed by the control section 420 according to the embodiment.

FIG. 5 is a diagram for describing a notification process performed by the control section 420 according to the embodiment.

FIG. 6 is a flowchart illustrating a flow of operation of the system 1 according to the embodiment.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

### Embodiment

<<Configuration Example>>

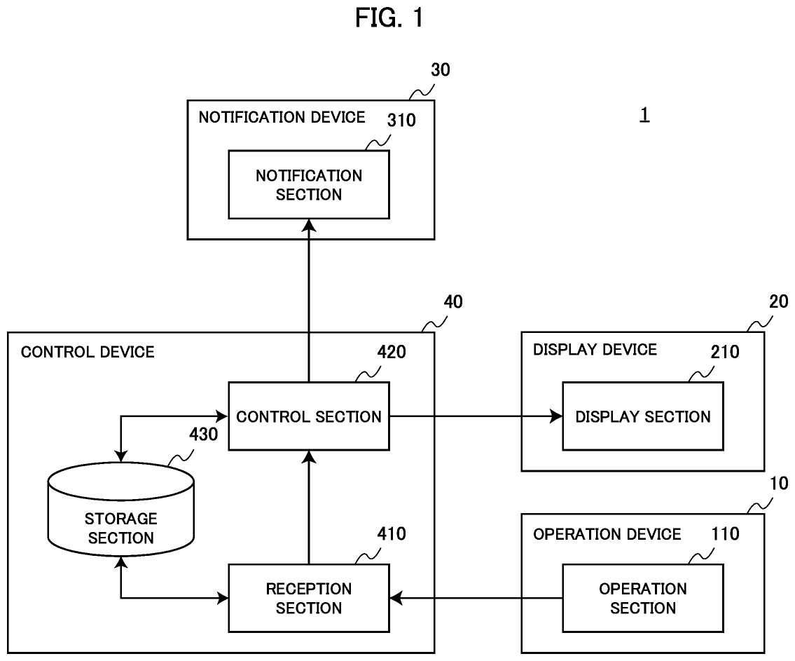

First, a configuration example of a system 1 according to an embodiment of the present invention will be described. FIG. 1 is a diagram illustrating a functional configuration example of the system 1 according to the present embodiment. As illustrated in FIG. 1, the system 1 according to the present embodiment includes an operation device 10, a display device 20, a notification device 30, and a control device 40, for example.

(Operation Device 10)

The operation device 10 according to the present embodiment is a device to be operated by a user. For example, the operation device 10 according to the present embodiment may be a touchpad, a trackball, a mouse, a scroll wheel, a slide switch, or the like. The operation device 10 according to the present embodiment includes an operation section 110.

The operation section 110 according to the present embodiment has a function of detecting operations performed by the user. Therefore, the operation section 110 may include various kinds of detection functions corresponding to modes of the operation device 10. For example, in the case where the operation device 10 is the touchpad, the operation section 110 may include a pressure-sensitive sensor or a capacitance sensor. The pressure-sensitive sensor changes pressure that varies in response to an operation performed by the user, into an electrical signal. The capacitance sensor converts variation in capacitance depending on an operation performed by the user, into an electrical signal. In addition, the operation section 110 may include a switch for detecting a push operation performed by the user. The operation section 110 transmits a signal related to the detected operation performed by the user, to the control device 40.

(Display Device 20)

The display device 20 according to the present embodiment is a device that displays visual information such as an image. The display device 20 according to the present embodiment may be various kinds of display devices. The display device 20 according to the present embodiment includes a display section 210.

The display section 210 according to the present embodiment may display an image on the basis of the signal input from the control device 40. For example, the display section 210 moves at least one target image on a display area, on the basis of the signal input from the control device 40. Here, the target image means an image to be operated by the user among images displayed on the display section 210. For example, the target image according to the present embodiment may be an icon, a button, a thumbnail, a character string, or the like.

(Notification Device 30)

The notification device 30 according to the present embodiment is a device that makes various kinds of notifications to the user under the control of the control device 40. The notification device 30 according to the present embodiment includes a notification section 310.

The notification section 310 according to the present embodiment makes a notification on the basis of a control signal input from the control device 40. Therefore, the notification section 310 includes various kinds of output mechanisms corresponding to modes of the notification. For example, in the case of making a notification to be tactually perceived by the user, the notification section 310 may include various kinds of actuators that make it possible to generate vibratory stimuli, electric stimuli, pressing stimuli, hot/cold stimuli, and the like. For example, in the case of making notifications by using the vibratory stimuli, the notification section 310 may include an eccentric motor (eccentric rotating mass vibration motor (ERM)), a linear vibrator (linear resonant actuator (LRA)), a piezoelectric element, a voice coil motor, or the like. Alternatively, the notification section 310 may include a plurality of actuators of same or different types.

Alternatively, for example, in the case of making a notification to be aurally perceived by the user, the notification section 310 may include a speaker or an amplifier. Alternatively, for example, in the case of making a notification to be visually perceived by the user, the notification section 310 may include various kinds of lights, which emit light.

Note that, the notification made by the notification section 310 may be a combination of a plurality of stimuli of different modes. For example, the notification section 310 may make a notification by using vibration and sound. Alternatively, for example, the notification section 310 may make a notification by using electric stimuli and light. The notification section 310 according to the present embodiment makes a notification by using at least one of the vibration, sound, and light under the control of the control device 40.

(Control Device 40)

The control device 40 according to the present embodiment is a device that receives an operation performed by the user on the operation device 10 and controls notification in tandem with behavior of an image displayed on the display device 20. The control device 40 according to the present embodiment includes a reception section 410, a control section 420, and a storage section 430.

The reception section 410 according to the present embodiment has a function of receiving an operation performed on at least one operation section 110. For example, the reception section 410 receives an electrical signal generated by the operation section 110 on the basis of a detected operation performed by the user, and receives an operation corresponding to the electrical signal.

The control section according to the present embodiment executes a notification process of controlling the notification section 310 in such a manner that the notification section 310 treats at least one of images displayed on the display section 210 as the target image and makes a notification in tandem with at least one of the target images that move depending on a content of the operation received by the reception section 410. The function of the control section 420 may be implemented by cooperation of a processor such as a central processing unit (CPU) random access memory (RAM), and the like. Details of the notification process according to the present embodiment will be described later.

The storage section 430 according to the present embodiment stores various kinds of information related to operation of the control device 40. For example, the storage section 430 stores a program or the like to be used by the control section 420 for executing the notification process.

The functional configuration example of the system 1 according to the present embodiment has been described above. Note that, the functional configuration described above with reference to FIG. 1 is a mere example. The functional configuration of the system 1 according to the present embodiment is not limited thereto. For example, the operation device 10 and the notification device 30 may be integrated with each other. In this case, it is possible to makes a notification as feedback about the operation performed by the user on the operation device 10, by making the notification by using the vibratory stimulus, for example. The functional configuration of the system 1 according to the present embodiment may be flexibly modified in accordance with specifications and operations.

In addition to the above-described features, one of features of the system 1 according to the present embodiment is that the operation section 110 and the display section 210 according to the present embodiment are arranged at respective positions where it is difficult for the user to intuitively understand a correspondence between operation coordinates and display coordinates, the operation coordinates defining a position of an operation performed on the operation section 110, the display coordinates defining a position of an image displayed on the display section 210. For example, the operation section 110 and the display section 210 may be arranged in such a manner that separate positions of the operation section 110 and the display section 210 serve as the positions where it is difficult for the user to intuitively understand the correspondence between the operation coordinates and the display coordinates.

On the other hand, examples of a mechanism that allows the user to intuitively understand the correspondence between the operation coordinates and the display coordinates include a touchscreen installed on a smartphone or the like. In the case of performing an operation on the touchscreen, it is possible for the user to select the target image such as an icon displayed on an area serving as both a display area and an operation area, by touching a display position of the target image while visually recognizing the target image. In this case, it can be said that the operation coordinates are almost completely identical to the display coordinates.

On the other hand, in the case where the operation section 110 and the display section 210 are prepared as separate devices, sometimes it is difficult for the user to intuitively understand the correspondence between operation coordinates and the display coordinates. For example, it is assumed that the operation section 110 and the display section 210 are installed at separate positions in a vehicle interior of a mobile object such as a vehicle. As an example, the operation section 110 may be arranged on a spoke of a steering wheel. In addition, as an example, the display section 210 may be configured as (a portion of) an instrument panel located in front of a driver's seat, or may be arranged on a center console or the like. In this case, the user operates the target image displayed on the display section 210 by using the operation section 110 arranged at a position separate from the display section 210. However, in this case, it is difficult for the user to gaze at both the operation section 110 and the display section 210 at a same time. In addition, in the case where the user is a driver, it is difficult for the user to continuously gaze at the display section 210 or the operation section 110. Therefore, it may be impossible for the user to intuitively understand the correspondence between the operation coordinates and the display coordinates. This may make it impossible for the user to correctly perform a desired operation, or there is a possibility that the user repeatedly performs a meaningless operation.

Alternatively, for example, in the case where the touchscreen serves as a portion of the operation section 110 and is arranged on a back side of a smartphone or a gamepad, it is also difficult for the user to intuitively understand the correspondence between the operation coordinates and the display coordinates. As described above, the operation section 110 and the display section 210 according to the present embodiment are not necessarily installed on separate devices.

The technical idea of the present invention was conceived by focusing on the above-described points, and makes it possible to further improve operability of the system that adopts the GUI. Therefore, the control device 40 according to an embodiment of the present invention includes: the reception section 410 configured to receive an operation performed on the at least one operation section 110; and the control section 420 configured to executes the notification process of controlling the notification section 310 in such a manner that the notification section 310 treats at least one of images displayed on the display section 210 as the target image and makes a notification in tandem with at least one of the target images that move depending on a content of the operation received by the reception section 410. In addition, one of features of the operation section 110 and the display section 210 according to an embodiment of the present invention is that the operation section 110 and the display section 210 are arranged at respective positions where it is difficult for the user to intuitively understand the correspondence between the operation coordinates and the display coordinates, the operation coordinates defining a position of an operation performed on the operation section 110, the display coordinates defining a position of an image displayed on the display section 210. Next, details of the notification process performed by the control device 40 will be described.

<Details>

Next, it is mainly assumed that the system 1 according to the present embodiment is installed in the vehicle interior of the mobile object such as the vehicle. For example, at least one or more operation sections 110 may be installed on the spoke of the steering wheel. In addition, it is assumed that the notification section 310 is integrated with the operation section 110, and makes a notification by using a vibratory stimulus. In addition, the display section 210 may be prepared as (a portion of) the instrument panel, or may be installed on the center console.

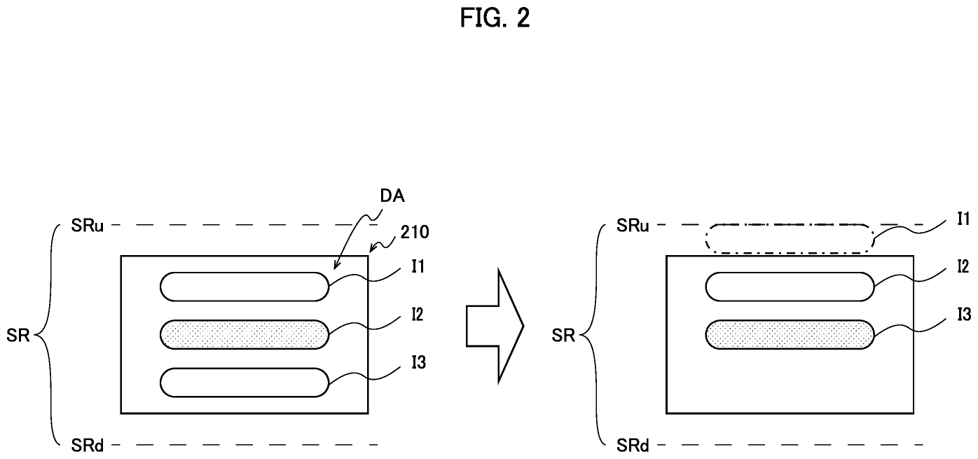

Next, details of the notification process performed by the control device 420 will be described with reference to specific examples. FIG. 2 to FIG. 5 are diagrams for describing notification processes performed by the control section 420. For example, in the case of the example illustrated in FIG. 2, the control section 420 executes the notification process on the basis of a range (movable range) where it is possible for the target image to move depending on a content of an operation.

FIG. 2 illustrates an example in which three target images I1 to I3 are displayed in a display area DA of the display section 210 and move in response to an operation performed by the user. The target images I1 to I3 may be respective icons corresponding to predetermined functions. The functions corresponding to the target images I1 to I3 may be arbitrarily designed. For example, in the case where the system 1 is installed in the mobile object such as the vehicle, the target images I1 to I3 may correspond to functions such as a vehicle control function, an air-conditioning control function, a navigation control function, and a sound control function.

In this case, it is possible for the user to move or select the target images I1 to I3 displayed in the display area DA of the display section 210 by performing an operation on the operation section 110. Note that, in the case of the example illustrated in FIG. 2, it is assumed that the user can move (scroll) the target images I1 to I3 in an up/down direction by performing a sliding (swipe) operation on the operation section 110 in the up-down direction. In other words, the control section 420 may instruct the display section 210 to move the target images I1 to I3 on the basis of the sliding operation received by the reception section 410. In addition, at this time, the control section 420 may instruct the display section to move the plurality of target images I1 to I3 uniformly. In this case, it is possible for the user to move the plurality of target images I1 to I3 at a same time through the single sliding operation.

In addition, in the case of the example illustrated in FIG. 2, it is assumed that a target image located in a vicinity of a middle of the display area DA in the up/down direction is in a selected state. In other words, it is possible for the user to scroll the target images I1 to I3 in the up/down direction by performing the sliding operation on the operation section 110 in the up/down direction, and it is possible for the user to select any of the target images by moving the any of the target images to the vicinity of the middle of the display area DA in the up/down direction (hereinafter, simply referred to as the vicinity of the middle). For example, a state where the target image 12 is selected is illustrated in the left side of FIG. 2.

In the case where the user intends to select the target image I3 instead of the target image 12 in the above-described state, the user performs the sliding operation on the operation section 110 in an up direction (or in a down direction), and moves the target image 12 to the vicinity of the middle of the display area DA. However, here, in the case where the sliding operation is performed excessively although the movable range of the target images I1 to I3 is not limited in the up/down direction, there is a possibility that all the target images I1 to I3 go out of the display area DA and the user loses the target images I1 to I3. Therefore, in this example, it is assumed that a movable range SR of the target images OI1 to I3 is decided in advance. For example, the movable range SR may be set by using an upper movement limit boundary SRu and a lower movement limit boundary SRd.

In the case of the example illustrated in FIG. 2, the movement limit boundary SRu is set in such a manner that the target image I3 is located in the vicinity of the middle of the display area DA when an upper end of the target image I1 reaches the movement limit boundary SRu. In addition, the movement limit boundary SRd is set in such a manner that the target image I1 is located in the vicinity of the middle of the display area DA when a lower end of the target image I3 reaches the movement limit boundary SRd.

On the other hand, in the case where the user does not gaze at the display area DA although the movement limit boundaries SR of the target images I1 to I3 are set as described above, there is a possibility that the target image I1 reaches the movement limit boundary SRu (that is, the target image I3 is in the selected state) as illustrated in the right side of FIG. 2 but the user continues to perform the sliding operation without being aware that the target image I1 has already reached the movement limit boundary SRu. In a similar way, there is a possibility that the target image I3 reaches the movement limit boundary SRd (that is, the target image I1 is in the selected state) but the user continues to perform the sliding operation without being aware that the target image I3 has already reached the movement limit boundary SRd.

To avoid the above-described situations, the control section 420 according to the present embodiment may execute the notification process when the at least one of the plurality of target images reaches an end of the movable range SR. For example, in the case of the example illustrated in the right side of FIG. 2, the control section 240 may cause the notification section 310 to make a notification by using a vibratory stimulus or the like on the basis that the target image I1 has reached the movement limit boundary SRu through the sliding operation. The movement limit boundary SRu is one of ends of the movable range SR. In a similar way, the control section 240 may cause the notification section 310 to make a notification on the basis that the target image I3 has reached the movement limit boundary SRd through the sliding operation. The movement limit boundary SRd is one of the ends of the movable range SR. Under the control of the control section 420, it is possible for the user to intuitively understand that a target image has reached an end of the movable range SR, and it is possible to achieve an effect of omitting a subsequent sliding operation, which is not necessary.

Note that, the control section 420 may cause the notification section 310 to make notifications in different modes between the case where the target image I1 has reached the movement limit boundary SRu and the case where the target image I3 has reached the movement limit boundary SRd. The modes may have various kinds of parameters corresponding to stimuli to be used for the notification such as the number of times of the notification, notification time, magnitude of the notification, and the like. For example, in the case of making notifications by using vibratory stimuli, it is possible for the control section 420 to cause the notification section 310 to make notifications by using a vibratory stimuli of different modes by changing a parameter related to acceleration, frequency, or the like.

In addition, FIG. 2 illustrates the case where the movable range SR is decided by the movement limit boundary SRu set in the up direction and the movement limit boundary SRd set in the down direction. However, the settings of the movable range according to the present embodiment are not limited thereto. The movement limit boundaries are not limited to the upper movement limit boundary and the lower movement limit boundary. The movement limit boundaries SR may be set in any directions. For example, the movable range SR may be decided by a movement limit boundary set in a left direction and a movement limit boundary set in the right direction. Alternatively, the movable range SR may be decided by movement limit boundaries set in eight directions including up, down, left, right, and oblique directions. In addition, the movement limit boundaries according to the present embodiment are not necessarily the two movement limit boundaries set in opposed directions. For example, the movable range SR may be decided only by the movement limit boundary SRu set in the up direction. In this case, the movable range of the target image is limited in the up direction, but the target image can move unlimitedly in the down direction.

In addition, FIG. 2 illustrates the example in which the target images are icons corresponding to the predetermined functions. However, the target images according to the present embodiment are not limited thereto. For example, in the case of performing control as described above on the basis of the movable range SR, the target image may be a scrollable (spinner) input form for selecting and inputting numbers, a date, or the like.

In addition, for example, the target image according to the present embodiment may be an image (referred to as a pull-out image in this specification) that is displayed when the image is pulled out through the sliding operation performed on a front surface of an image displayed in the display area DA. For example, the pull-out image is displayed in such a manner that the pull-out image is pulled out from one end (first edge) toward another end (second edge) of the display area DA on a front surface of an image related to any application when the sliding operation is performed from the one end to the other end while the image related to the any application is displayed. For example, the pull-out image may be an image to be used for configuring general setting of the system 1.

Even in the case where the sliding operation is performed excessively with regard to the above-described pull-out image, it is also possible to set the movable range RS in such a manner that the pull-out image does not go out of the display area DA. In addition, the control section 420 may execute the notification process to prevent the user from continuing to perform unnecessary sliding operation without being aware that an end of the pull-out image has reached a movement limit boundary.

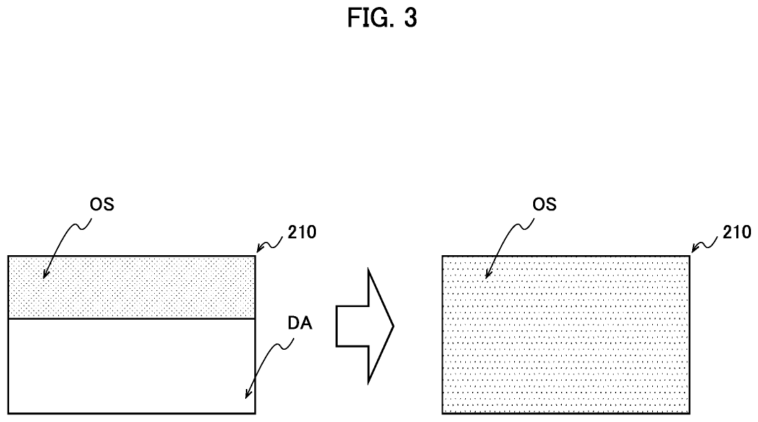

A pull-out image OS that is pulled out from an upper end of the display area DA is exemplified in the left side of FIG. 3. In this case, the user treats the upper end of the display area DA as the first edge and performs the sliding operation from the first edge toward a second edge (lower end), which is opposed to the first edge. This allows the pull-out image OS to be pulled out toward the down direction.

The control section 420 may execute the notification process when the lower end of the pull-out image OS has reached the second edge (that is, lower end) of the display area DA as illustrated in the right side of FIG. 3 through the above-described sliding operation received by the reception section 410. In this case, the second edge of the display area DA may serve as the movement limit boundary. Under the control of the control section 420, it is possible for the user to intuitively understand that the pull-out image OS has reached the movement limit boundary, that is, the whole pull-out image OA is displayed. Therefore, it is possible to achieve the effect of omitting a subsequent sliding operation, which is not necessary.

Note that, FIG. 3 illustrates the example in which the second edge of the display area DA serves as the movement limit boundary. However, the settings of the movement limit boundaries related to the pull-out image are not limited thereto. The movement limit boundaries of the pull-out image may be any points between the first edge and the second edge. For example, the movement limit boundary related to the pull-out image may be a point (line) that is close to the first edge and that is a designated distance away from the second edge.

In addition, the first edge and the second edge according to the present embodiment are not limited to the upper end and the lower end of the display area DA, respectively. Each of the first edge and the second edge may be any edge of the display area DA. For example, the pull-out image may be pulled out from a left edge toward a right edge of the display area DA, or may be pulled out from an upper right edge toward a lower left edge of the display area D.

The specific examples of the notification process based on the movable range SR of the target images have been described above. Next, a notification process based on a positional relation between the target image and a specific area set in the display area DA according to the present embodiment will be described.

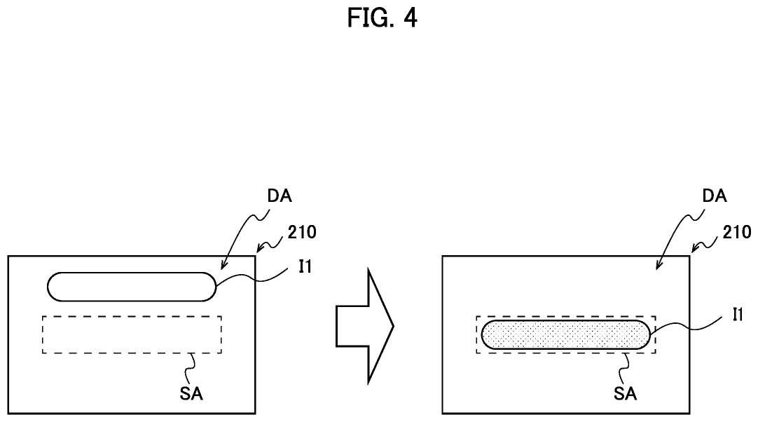

The left side of FIG. 4 illustrates a specific area SA and the target image I1. The specific area SA is set in the vicinity of the middle of the display area DA. The target image I1 is located outside the specific area SA. Here, the control section 420 executes the notification process in the case where the user has performed the sliding operation on the operation section 110 and the target image I1 has reached the inside of the specific area SA as illustrated in the right side of FIG. 4. Here, the case where the target image I1 has reached the inside of the specific area SA may mean a case where the whole target image I1 has entered the inside of the specific area SA, for example. On the other hand, the control section 420 may determine that the target image I1 has reached the inside of the specific area SA in the case where an end of the target image I1 comes into contact with an outer perimeter of the specific area SA in response to the sliding operation, or in the case where a portion of the specific area SA overlaps a portion of the specific area SA in response to the sliding operation.

For example, the above-described operation of moving the target image to the inside of the specific area SA may be an operation of executing a function associated with the target image. In addition, for example, the above-described operation of moving the target image to the inside of the specific area SA may be an operation of deleting an icon, a file, a folder, or the like corresponding to the target image (such as an operation of dragging the target image to a specific area SA, which is represented by a recycle bin image, for example). In addition, for example, the above-described operation of moving the target image to the inside of the specific area SA may be an operation of moving a target image corresponding to the icon, the file, the folder, or the like from a current storage position to another storage position (such as an operation of dragging the target image to a specific area SA, which is represented by a folder image, for example).

Under the control of the control section 420 according to the present embodiment as described above, it is possible for the user who has perceived the notification to intuitively understand that the process is received, and to complete a desired operation without gazing at the display area DA.

In addition, for example, it is also possible to apply the above-described control methods to an operation of searching for any point on a map displayed on the display area DA. In this case, the target image may be a pointer or the like that moves in response to the sliding operation. In addition, the specific area SA may be an area corresponding to the any point that the user intends to check on the map. Examples of the any point include a destination, a home spot such as the user's house, a spot classified into any genre such as a restaurant, a favorite spot set in advance by the user, and the like.

In this case, the control section 420 executes the notification process when the target image corresponding to the pointer or the like has reached the inside of the specific area SA through the sliding operation performed by the user as described above. Such control allows the user to intuitively perceive that a desired spot is present on a map without gazing at the map displayed in the display area DA.

In addition, at this time, the control section 420 may cause the notification section 310 to make notifications of different modes depending on types of the specific areas SA. For example, the control section 420 may cause the notification section 310 to make notifications of different modes between the case where the target image has reached a specific area SA corresponding to a restaurant, and the case where the target image has reached a specific area SA corresponding to a filling station. Such control makes allows the user to intuitively perceive different types of spots by only using the notifications.

However, the notification process based on the positional relation between the target image and the specific area SA is not limited to the case where the target image has reached the inside of the specific area SA.

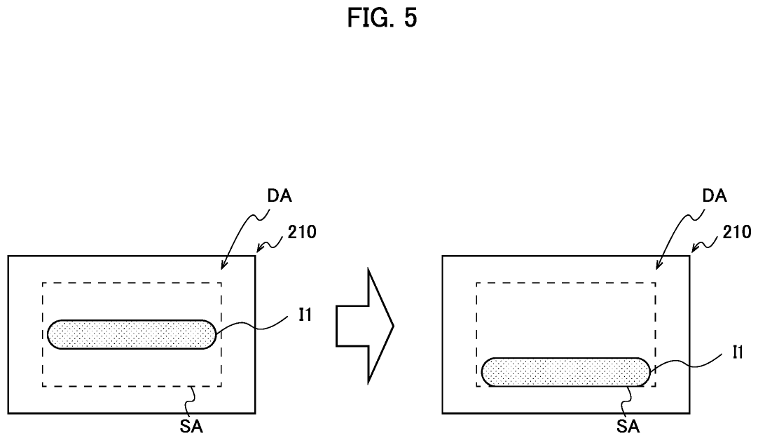

The left side of FIG. 5 illustrates a specific area SA and the target image I1. The specific area SA is set in the display area DA. The target image I1 is located inside the specific area SA. Here, the control section 420 executes the notification process in the case where the user has performed the sliding operation on the operation section 110 and the target image I1 has reached the outside of the specific area SA as illustrated in the right side of FIG. 5. Here, the case where the target image I1 has reached the outside of the specific area SA may mean a case where the whole target image I1 has gone out of extension of the specific area SA, for example. On the other hand, the control section 420 may determine that the target image I1 has reached the outside of the specific area SA in the case where an end of the target image I1 comes into contact with an inner perimeter of the specific area SA in response to the sliding operation, or in the case where a portion of the specific area SA overlaps a portion of the specific area SA in response to the sliding operation.

For example, the above-described operation of moving the target image to the outside of the specific area SA may be a process of stopping the function associated with the target image or a process of canceling the selected state. In addition, for example, the above-described operation of moving the target image to the outside of the specific area SA may be an operation of moving the icon, the file, the folder, or the like corresponding to the target image from a current storage position to another storage position (such as an operation of moving an icon stored in a page A displayed in the area serving as both the display area DA and the specific area SA to a page B that is not displayed in the display area DA, for example).

Under the control of the control section 420 according to the present embodiment as described above, it is possible for the user who has perceived the notification to intuitively understand that the process is received, and to complete a desired operation without gazing at the display area DA.

<Flow of Operation>

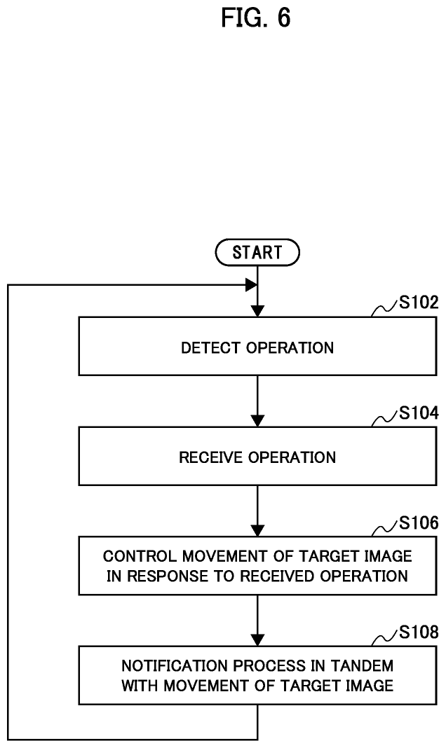

Next, a flow of operation of the system 1 according to the present embodiment will be described in detail. FIG. 6 is a flowchart illustrating the flow of operation of the system 1 according to the present embodiment.

As illustrated in FIG. 6, the operation section 110 first detects an operation performed by the user (Step S102). The operation section 110 outputs a signal related to the detected operation to the reception section 410.

Next, the reception section 410 receives the operation corresponding to the signal (Step S104) on the basis of the signal input in Step S102. The reception section 410 inputs information related to the received operation into the control section 420.

Next, on the basis of the signal input in Step S104, the control section 420 controls the display section 210 in such a manner that the target image moves in response to the operation received by the reception section 410 (Step S106).

Next, the control section 420 executes the notification process (Step S108) in tandem with the movement of the target image performed in Step S106.

The system 1 according to the present embodiment may repeatedly execute the respective steps described above until an instruction to stop the notification process is issued.

<Supplement>

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the appended claims, and it should be understood that they will naturally come under the technical scope of the present invention.

Note that, a series of processes performed by the respective devices described in this specification may be implemented by any of software, hardware, and a combination of software and hardware. A program that configures the software is stored in advance in, for example, a non-transient storage medium installed inside or outside each of the devices. In addition, for example, when a computer executes each of the programs, the program is loaded into RAM, and executed by a processor such as a CPU. The storage medium may be a magnetic disk, an optical disc, a magneto-optical disc, flash memory, or the like, for example. Alternatively, the above-described computer program may be distributed via a network without using the storage medium, for example.

### REFERENCE SIGNS LIST

1 system
10 operation device
110 operation section
20 display device
210 display section
30 notification device
310 notification section
40 control device
410 reception section
420 control section

1. A control device comprising:
a reception section configured to receive an operation performed on at least one operation section; and
a control section configured to execute a notification process of controlling a notification section in such a manner that the notification section treats at least one of images displayed on a display section as a target image and makes a notification in tandem with the at least one target image that moves depending on a content of the operation received by the reception section,
wherein the operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

2. The control device according to claim 1,
wherein the operation section and the display section are arranged in such a manner that separate positions of the operation section and the display section serve as the positions where it is difficult for the user to intuitively understand the correspondence between the operation coordinates and the display coordinates. control device.

3. The control device according to claim 1,
wherein the control section executes the notification process when the at least one target image reaches an end of a movable range that allows the at least one target image to move depending on the content of the operation.

4. The control device according to claim 3, wherein
in a case where there are a plurality of the target images, the target images move uniformly depending on the content of the operation, and
the control section executes the notification process when the at least one of the plurality of target images reaches an end of the movable range.

5. The control device according to claim 1,
wherein the control section executes the notification process on a basis of a positional relation between the target image and a specific area set in a display area of the display section.

6. The control device according to claim 5,
wherein the control section executes the notification process when the target image that has been located outside the specific area reaches an inside of the specific area in response to the operation.

7. The control device according to claim 5,
wherein the control section executes the notification process when the target image that has been located inside the specific area reaches an outside of the specific area in response to the operation.

8. The control device according to claim 3,
wherein the control section executes the notification process when the reception section receives an operation of moving the target image from a first edge toward a second edge of a display area of the display section and the target image reaches an end of the movable range, the second edge being opposed to the first edge.

9. The control device according to claim 1,
wherein, in the notification process, the control section causes the notification section to make a notification using at least one of vibration, sound, and light.

10. A system comprising:
at least one operation section;
a reception section configured to receive an operation performed on the operation section;
a display section configured to display at least one image; and
a control section configured to execute a notification process of controlling a notification section in such a manner that the notification section treats at least one of images displayed on the display section as a target image and makes a notification in tandem with the at least one target image that moves depending on a content of the operation received by the reception section,
wherein the operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.

11. A non-transitory computer readable storage medium having a program stored therein, the program causing a computer to achieve:
a reception function of receiving an operation performed on at least one operation section; and
a control function of executing a notification process of controlling a notification section in such a manner that the notification section treats at least one of images displayed on a display section as a target image and makes a notification in tandem with the at least one target image that moves depending on a content of the operation received by the reception function,
wherein the operation section and the display section are arranged at respective positions where it is difficult for a user to intuitively understand a correspondence between operation coordinates and display coordinates, the operation coordinates defining a position of the operation performed on the operation section, the display coordinates defining a position of the image displayed on the display section.
